(19) United States
(12) Patent Application Publication
(10) Pub. No.: US 2009/0057345 A1
(43) Pub. Date: Mar. 5, 2009

(54) FLUID DISPENSER

(76) Inventor: Stephen A. Dukes, North Baltimore, OH (US)

Correspondence Address: FRASER CLEMENS MARTIN & MILLER LLC, 28366 KENSINGTON LANE, PERRYSBURG, OH, 43551, US

(21) Appl. No.: 12/196,494

(22) Filed: Aug. 22, 2008

Related U.S. Application Data
(60) Provisional application No. 60/969,210, filed on Aug. 31, 2007.
(60) Provisional application No. 60/973,279, filed on Sep. 18, 2007.
(60) Provisional application No. 61/014,482, filed on Dec. 18, 2007.

(51) Int. Cl. B65D 88/54; B67D 5/06

(52) U.S. Cl. 222/321.1; 222/181.3

(57) ABSTRACT

A fluid dispenser is disclosed including a hollow pump cylinder having a first end and a second end, wherein the cylinder is adapted to selectively receive one of a liquid pump assembly and a foam pump assembly and slideably supports an actuator.

### CROSS-REFERENCE TO RELATED APPLICATIONS

This application claims the benefit of U.S. Provisional Patent Application Ser. No. 60/969,210 filed Aug. 31, 2007; 60/973,279 filed Sep. 18, 2007; and 61/014,482 filed Dec. 18, 2007.

### FIELD OF THE INVENTION

The invention relates to a fluid dispenser, and more particularly, to a fluid dispenser for dispensing a soap including a hollow pump cylinder for selectively receiving a liquid or foam pump assembly.

### BACKGROUND OF THE INVENTION

It is well established that washing hands is essential to cleanse the hands of pathogens (including bacteria and viruses) and chemicals, which can cause personal harm or disease. This is especially important for people who work in the food and medical fields. Customarily, fluid dispensers for dispensing a soap are located in areas where people are required to frequently cleanse their hands. Typically, such fluid dispensers include a reservoir containing the soap and a dispensing mechanism. The dispensing mechanism usually includes a pump assembly and an actuator, such as a lever or a button, operated by a pushing or a pulling motion. The actuator operates the pump assembly to effectively discharge a metered volume of the soap. Normally, the pump assembly of the fluid dispenser is either a foam pump assembly or a liquid pump assembly.

One such foam pump assembly is described in U.S. Patent Application Publication No. 2006/0157512 to van der Heijden entitled DISPENSING DEVICE WITH PISTON PUMP. A foam dispensing device is disclosed having a liquid pump and an air pump disposed in a cylindrical housing. The liquid pump includes a hollow liquid piston having at least one sealing element affixed thereto. The liquid piston in cooperation with the housing forms a liquid pump chamber.

The air pump includes an air piston. The air piston in cooperation with the housing forms an air pump chamber. Both the liquid pump and the air pump are provided with an inlet valve and an outlet valve. In operation, the liquid piston and the air piston are in a normally retracted position in the housing.

The liquid piston and the air piston are simultaneously moved forward. The forward movement of the liquid piston increases a pressure of the liquid in the liquid chamber, causing the outlet valve to open allowing the fluid to flow through the liquid piston to a mixing chamber. The forward movement of the air piston increases a pressure of the air in the air chamber, causing the outlet valve to open allowing the air to flow to the mixing chamber. In the mixing chamber, the liquid and the air combine to produce a foam, which is guided through a channel to a dispensing aperture.

The liquid piston and the air piston are then caused to move to a retracted position by a spring disposed in the foam dispensing device. Movement of the liquid piston causes a new volume of liquid to be drawn from a fluid reservoir through the liquid inlet valve and into the liquid pump chamber. Movement of the air piston causes a new volume of air to be drawn from the atmosphere through the air inlet valve and into the air pump chamber.

There are various dispensing mechanisms including a pump assembly for dispensing soap in a liquid state. One such pump assembly is disclosed in U.S. Pat. No. 4,474,307 to Chappell entitled DOWN FLOW APPARATUS FOR DISPENSING VISCOUS MATERIAL AND METHOD OF LOADING SAME. A piston assembly is disclosed including a hollow piston rod and a hollow cylindrical piston adapted to receive a valve therebetween. The valve controls a flow of fluid from the fluid reservoir. In operation, the piston is in a retracted position in the pump bore. Thereafter, the piston is moved forward, increasing a pressure of the fluid, causing the valve to open to allow the fluid to flow through the piston and the piston rod to an outlet.

A problem with such fluid dispensers is that the piston pump housing or bore is adapted to receive only one type of pump assembly, preventing the interchangeability of the pump assembly. This structure therefore limits the fluid dispenser to either a foam dispenser, or a liquid dispenser.

It would be desirable to produce a fluid dispenser for dispensing a soap capable of selectively receiving one of a liquid pump assembly and a foam pump assembly, which is economically and relatively easily manufactured and installed.

### SUMMARY OF THE INVENTION

The above objective, as well as, others may be surprisingly achieved by a fluid dispenser for dispensing a soap including a hollow pump cylinder capable of selectively receiving one of a liquid pump assembly and a foam pump assembly.

In an embodiment of the invention, the housing for storing and dispensing a fluid comprises: a hollow pump cylinder having an inner wall formed to define a cavity for selectively receiving a liquid pump assembly and a foam pump assembly.

In another embodiment of the invention, the fluid dispenser comprises: a housing for selectively receiving one of a liquid pump assembly and a foam pump assembly, the liquid pump assembly including a hollow piston rod, a hollow piston cup, and a valve, the housing having a hollow pump cylinder formed therein including a first end having an inlet in fluid communication with a fluid reservoir, and a second end having a larger diameter than a diameter of the first end; and an actuator adapted to operate both the liquid pump assembly and the foam pump assembly.

In another embodiment of the invention, the fluid dispenser comprises: a housing having a front wall, opposing sidewalls, a rear wall, and a base, wherein the walls are substantially vertical and cooperate to define a fluid reservoir, and wherein the base includes a hollow pump cylinder formed therein, the hollow pump cylinder including a first end having an inlet in fluid communication with the fluid reservoir, a second end having a larger diameter than a diameter of the first end, and a plurality of guide rails formed thereon, and wherein the pump cylinder is adapted to selectively receive one of a liquid pump assembly and a foam pump assembly, the liquid pump assembly including a hollow piston cup, a valve, and a hollow piston rod having a positioning mechanism formed thereon, wherein the positioning mechanism is adapted to be slideably received in the second end of the pump cylinder; and an actuator adapted to operate both the liquid pump assembly and the foam pump assembly, the actuator slideably supported on the guide rails of the pump cylinder.

### DESCRIPTION OF THE DRAWING

The above, as well as other advantages of the present invention, will become readily apparent to those skilled in the art from the following detailed description of various embodiments when considered in the light of the accompanying drawings in which:

FIG. 1 is a perspective view of a fluid dispenser;

FIG. 2 is a front elevational view of a fluid dispenser housing according to an embodiment of the invention;

FIG. 3 is a cross-sectional view of the fluid dispenser housing illustrated in FIG. 2;

FIG. 4 is a cross-sectional view of the fluid dispenser housing as illustrated in FIG. 3 having a liquid pump assembly disposed therein in a first position;

FIG. 5 is a cross-sectional view of the fluid dispenser housing as illustrated in FIG. 3 having the liquid pump assembly shown in FIG. 4 disposed therein in a second position;

FIG. 6 is a perspective view of a piston rod for the liquid pump assembly illustrated in FIGS. 4 and 5, shown at a reduced scale;

FIG. 7 is a cross-sectional view of the fluid dispenser housing as illustrated in FIG. 3 showing an alternative liquid pump assembly in a first position;

FIG. 8 is a cross-sectional view of the fluid dispenser housing as illustrated in FIG. 3 showing the alternative liquid pump assembly illustrated in FIG. 7 in a second position;

FIG. 9 is a cross-sectional view of the fluid dispenser housing as illustrated in FIG. 2 having a foam pump assembly disposed therein in a first position; and

FIG. 10 is a cross-sectional view of the fluid dispenser housing as illustrated in FIG. 3 having the foam pump assembly shown in FIG. 9 disposed therein in a second position.

### DETAILED DESCRIPTION OF THE PREFERRED EMBODIMENT

The following detailed description and drawings describe and illustrate various embodiments of the present invention. The description and drawings serve to enable one skilled in the art to make and use the invention, and is not intended to limit the scope of the invention in any manner. It is understood that materials other than those described can be used without departing from the scope and spirit of the invention.

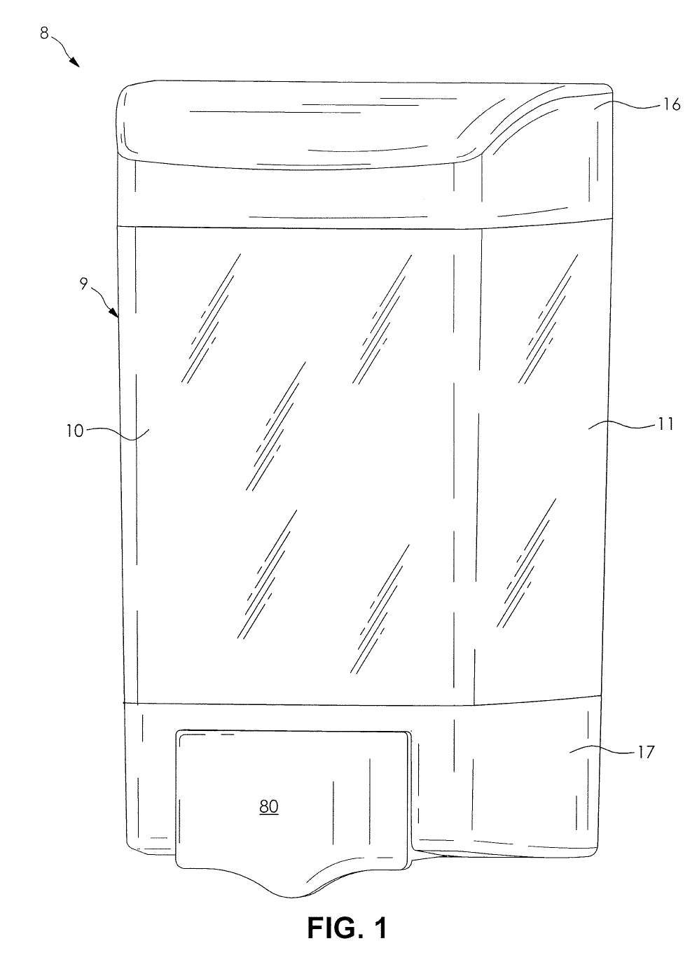

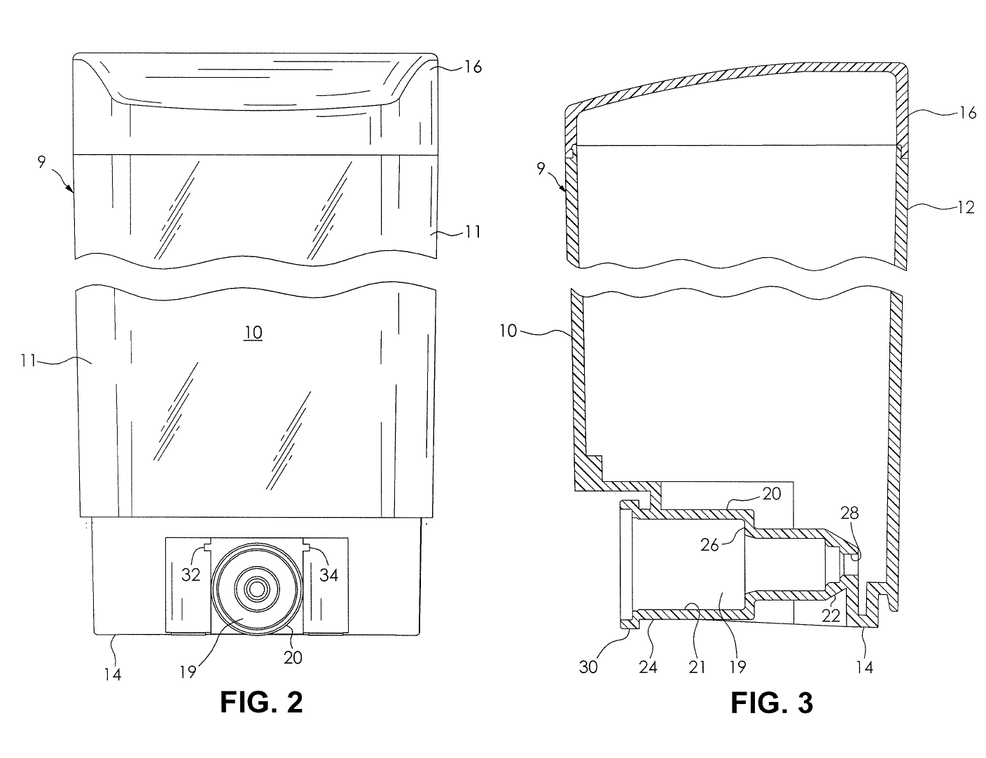

FIG. 1 shows a fluid dispenser 8. The fluid dispenser 8 may be formed from a variety of materials including plastic. According to one embodiment of the invention, the fluid dispenser 8 includes a housing 9. As shown in FIG. 2, the housing 9 is generally rectangular in shape and includes a front wall 10, a pair of spaced-apart opposing sidewalls 11, a rear wall 12 as shown in FIG. 3, and a base 14. The front wall 10, opposing sidewalls 11, and rear wall 12 of the housing 9 are substantially vertical and cooperate to define a fluid reservoir. A closure 16 is removably disposed on an upper portion of the housing 9. The fluid dispenser 8 may also include a base cover 17, as shown in FIG. 1, and a hanger plate (not shown), if desired.

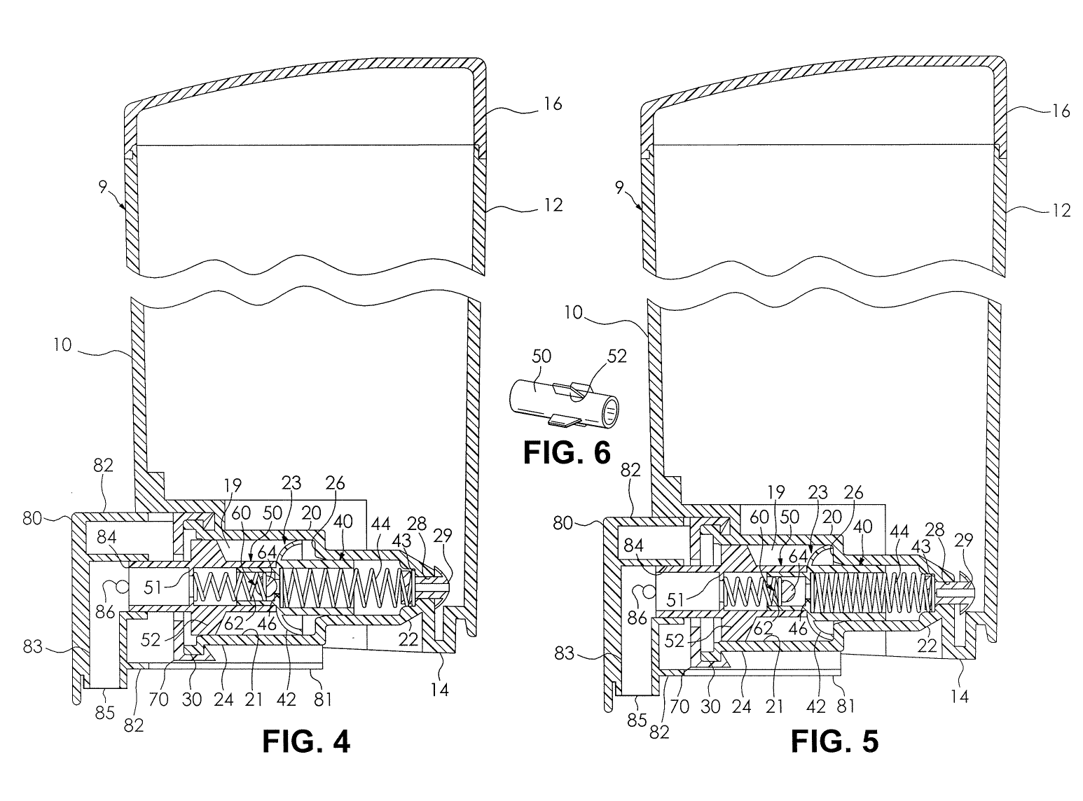

A pump cylinder 20, having an inner wall 21, is formed in the base 14 of the housing 9. The inner wall 21 is formed to define a cavity 19. The cylinder 20 is in fluid communication with the fluid reservoir. It is understood that the fluid reservoir can include a remote source of fluid, such as a container of soap, for example. As illustrated in FIG. 3, the cylinder 20 includes a substantially closed first end 22 and a substantially open second end 24. The first end 22 having a diameter smaller than a diameter of the second end 24. A shoulder 26 is formed at intermediate the first end 22 and the second end 24. The first end 22 includes an inlet 28 in fluid communication with the fluid reservoir. The inlet 28 is adapted to receive a valve 29 therein as shown in FIGS. 4 and 5. Although the valve 29 shown is a hollow insert slideably disposed in the inlet 28, it is understood that the valve 29 can be any type of valve as desired. An annular lip 30 is formed at the second end 24 of the cylinder 20. Spaced-apart guide rails 32, 34 shown in FIG. 2 are formed to extend laterally outwardly in opposite directions from an outer surface of the cylinder 20, and extend in a direction substantially parallel to a longitudinal axis of the cylinder 20.

In the embodiment shown in FIG. 4, the cavity 19 of the cylinder 20 is adapted to receive a liquid pump assembly 23 therein. The liquid pump assembly 23 includes a hollow piston cup 40, a hollow piston rod 50, and a valve 60. The hollow piston cup 40 has a generally circular cross-sectional shape and includes an inlet end and an outlet end. A diameter of the inlet end of the piston cup 40 is larger than a diameter of the outlet end of the piston cup 40. The inlet end is slideably received within the first end 22 of the cylinder 20 to create a substantially fluid-tight seal between the inlet end of the piston cup 40 and the inner wall 21 of the cylinder 20. A cup-shaped annular collar 42 is formed intermediate the inlet end and the outlet end of the piston cup 40. The collar 42 is slideably received within the second end 24 of the cylinder 20 to create a substantially fluid-tight seal between the collar 42 and the inner wall 21 of the cylinder 20. The inlet end of the piston cup 40 is adapted to receive a first end of a spring 44 therein. A second end of the spring 44 abuts a shoulder 43 formed around the inlet 28 of the cylinder 20.

The piston rod 50 has a generally circular cross-sectional shape and includes an inlet end and an outlet end. The inlet end is adapted to receive the outlet end of the piston cup 40, to create a substantially fluid-tight interference fit therebetween. The outlet end of the piston rod 50 extends laterally outwardly from the second end 24 of the cylinder 20.

In the embodiment shown, the valve 60 includes a spring 62 and a ball 64. One end of the valve 60 is disposed in the outlet end of the piston cup 40. The other end of the valve 60 is disposed in the inlet end of the piston rod 50. An inwardly extending annular flange 46 having an aperture formed therein is provided in the outlet end of the piston cup 40 to facilitate a seating of the ball 64. The ball 64 is disposed between the flange 46 of the piston cup 40 and a first end of the spring 62. A second inwardly extending annular flange 51 having an aperture formed therein is provided intermediate the inlet end and the outlet end of the piston rod 50. A second end of the spring 62 abuts the flange 51. In the embodiment shown, a positioning mechanism 52 extends radially outwardly from an outer surface of the piston rod 50 intermediate the inlet end and the outlet end. The positioning mechanism 52 is slideably received within the second end 24 of the cylinder 20 for aligning the piston rod 50 within the cylinder 20 and guiding the piston rod 50 during reciprocal movement within the cylinder 20. The positioning mechanism 52 can be a solid annular collar as shown in FIGS. 4 and 5, a plurality of flutes as shown in FIG. 6, and the like, for example.

The liquid pump assembly 23 is secured in the cylinder 20 by affixing a closure ring 70 to the lip 30 of the cylinder 20. The closure ring 70 is affixed by any conventional means of attachment such as a snap fit, for example. The outlet end of the piston rod 50 extends through an aperture formed in the closure ring 70 for attachment to an actuator 80.

The actuator 80 includes opposing leg sections 81 and an interconnecting cross-member section 82 extending therebetween. The leg sections 81 cooperate with the guide rails 32, 34 provided on the outer surface of the cylinder 20 to slideably support the actuator 80 during operation. A discharge conduit 83 formed in the cross-member section 82 is generally L-shaped and includes an inlet 84 and a downwardly protruding outlet 85. The inlet 84 is adapted to receive the outlet end of piston rod 50, to create a substantially fluid-tight interference fit therebetween. The inlet 84 may include at least one radially inwardly extending protuberance 86 adapted to abut the outlet end of the piston rod 50.

In operation, the liquid pump assembly 23 and the actuator 80 are in a first or “at rest” position in the cylinder 20 and the valve 29 is in a first or “open” position, as shown in FIG. 4. Thereafter, an operator urges the actuator 80 in a first direction to slideably move the liquid pump assembly 23 within the cylinder 20 in respect of the longitudinal axis thereof to a second or “compressed” position, as shown in FIG. 5. Accordingly, the spring 44 disposed in the first end 22 of the cylinder 20 is compressed and a pressure within the first end 22 of the cylinder 20 and a force of a fluid mass disposed therein are increased. The increased pressure within the first end 22 and the force of the fluid mass disposed therein urge the valve 29 to a second or “closed” position, as shown in FIG. 5. The movement of the liquid pump assembly 23 within the cylinder 20 and the increased pressure within the first end 22 force the fluid mass into the inlet end of the piston cup 40. The force of the fluid mass opens the valve 60 disposed in the liquid pump assembly 23 by causing the ball 64 to unseat from the flange 46 formed in the piston cup 40 and the associated spring 62 to compress. With the valve 60 open, the fluid mass is permitted to flow through the hollow interior of the piston rod 50 and into and through the discharge conduit 83 of the actuator 80.

Once the pressure of the cylinder 20 has decreased and the force of the fluid mass is less than the resistance force of the spring 62, the spring 62 urges the ball 64 to a seated position against the flange 46 formed in the piston cup 40 to close the valve 60. The liquid pump assembly 23 is then caused by the resistance force of the spring 44 to slideably move in a second and opposite direction within the cylinder 20. Accordingly, the liquid pump assembly 23 is returned to the first position as shown in FIG. 4. The movement of the liquid pump assembly 23 to the first position causes the actuator 80 to also move in the second direction and return to the first position as shown in FIG. 4.

Further, a pressure within the fluid reservoir and a force of the fluid disposed in the fluid reservoir urges the valve 29 to the first position, as shown in FIG. 4. The fluid then flows by gravity from the fluid reservoir into the first end of the cylinder 20. As the fluid fills the cylinder 20, the inlet end of the piston cup 40 militates against the migration of the fluid into the second end 24 of the cylinder 20 and the accumulation of the fluid around the liquid pump assembly 23.

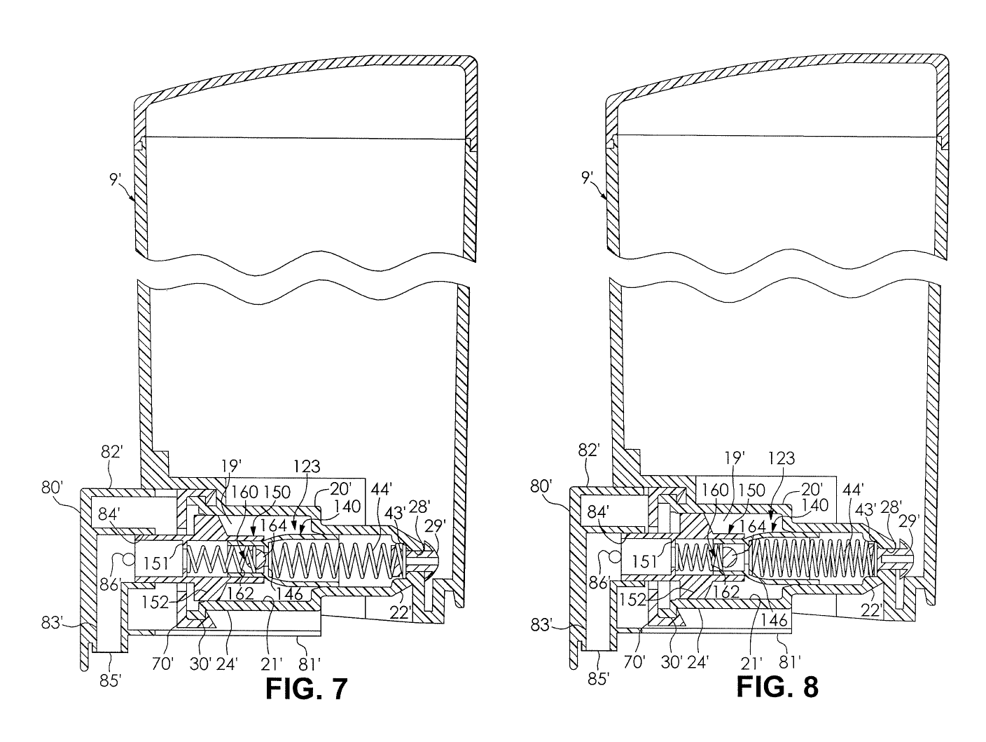

FIGS. 7 and 8 show a fluid dispenser housing 9′ similar to that shown in FIGS. 4 and 5 having an alternative liquid pump assembly 123 disposed therein. Reference numerals for similar structure in respect of the description of FIGS. 4 and 5 are repeated in FIGS. 7 and 8 with a prime (′) symbol.

The housing 9′ includes a pump cylinder 20′ formed therein. An inner wall 21′ of the pump cylinder 20′ is formed to define a cavity 19′ adapted to receive a liquid pump assembly 123 therein. The liquid pump assembly 123 includes a hollow piston cup 140, a hollow piston rod 150, and a valve 160. The hollow piston cup 140 has a generally circular cross-sectional shape and includes an inlet end and an outlet end. A diameter of the inlet end of the piston cup 140 is larger than a diameter of the outlet end of the piston cup 140. The inlet end of the piston cup 140 is provided with a campanular portion. The campanular portion is adapted to be slideably received within a substantially closed first end 22′ of the cylinder 20′ to create a substantially fluid-tight seal between the inlet end and the inner wall 21′ of the cylinder 20′. The inlet end of the piston cup 140 is adapted to receive a first end of a spring 44′ therein. A second end of the spring 44′ abuts a shoulder 43′ formed around an inlet 28′ of the cylinder 20′. The inlet 28′ of the cylinder 20′ is adapted to receive a valve 29′ therein. Although the valve 29′ shown is a hollow insert slideably disposed in the inlet 28′, it is understood that the valve 29′ can be any type of valve as desired.

The piston rod 150 has a generally circular cross-sectional shape and includes an inlet end and an outlet end. The inlet end is adapted to receive the outlet end of the piston cup 140, to create a substantially fluid-tight interference fit therebetween. The outlet end of the piston rod 150 extends laterally outwardly from a substantially open second end 24′ of the cylinder 20′.

In the embodiment shown, the valve 160 includes a spring 162 and a ball 164. One end of the valve 160 is disposed in the outlet end of the piston cup 140. The other end of the valve 160 is disposed in the inlet end of the piston rod 150. An inwardly extending annular flange 146 having an aperture formed therein is provided in the outlet end of the piston cup 140 to facilitate a seating of the ball 164. The ball 164 is disposed between the flange 146 of the piston cup 140 and a first end of the spring 162. A second inwardly extending annular flange 151 having an aperture formed therein is provided intermediate the inlet end and the outlet end of the piston rod 150. A second end of the spring 162 abuts the flange 151. In the embodiment shown, a positioning mechanism 152 extends radially outwardly from an outer surface of the piston rod 150 intermediate the inlet end and the outlet end. The positioning mechanism 152 is slideably received within the second end 24′ of the cylinder 20′ for aligning the piston rod 150 within the cylinder 20′ and guiding the piston rod 150 during reciprocal movement within the cylinder 20′. The positioning mechanism 152 can be a solid annular collar, a plurality of flutes, and the like, for example.

The liquid pump assembly 123 is secured in the cylinder 20′ by affixing a closure ring 70′ to a lip 30′ of the cylinder 20′. The closure ring 70′ is affixed by any conventional means of attachment such as a snap fit, for example. The outlet end of the piston rod 150 extends through an aperture formed in the closure ring 70′ for attachment to an actuator 80′.

The actuator 80′ includes opposing leg sections 81′ and an interconnecting cross-member section 82′ extending therebetween. The leg sections 81′ cooperate with guide rails provided on the outer surface of the cylinder 20′ to slideably support the actuator 80′ during operation. A discharge conduit 83′ formed in the cross-member section 82′ is generally L-shaped and includes an inlet 84′ and a downwardly protruding outlet 85′. The inlet 84′ is adapted to receive the outlet end of piston rod 150, to create a substantially fluid-tight interference fit therebetween. The inlet 84′ may include at least one radially inwardly extending protuberance 86′ adapted to abut the outlet end of the piston rod 150.

Since operation of the alternative liquid pump assembly 123 shown in FIGS. 7 and 8 is substantially similar to the operation of the liquid pump assembly 23 shown in FIGS. 4 and 5, for simplicity, the operation of the alternative liquid pump assembly 123 will be as described above.

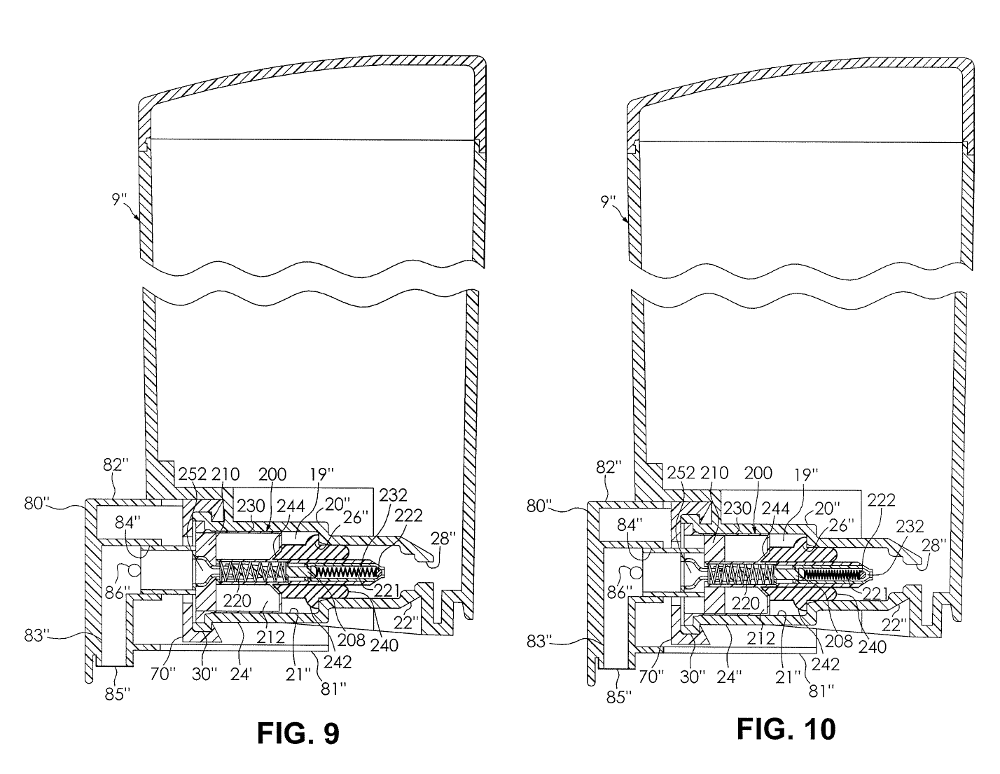

FIGS. 9 and 10 show a fluid dispenser housing 9″ similar to that shown in FIGS. 4, 5, 7 and 8 having a foam pump assembly 200 disposed therein. Reference numerals for similar structure in respect of the description of FIGS. 4, 5, 7, and 8 are repeated in FIGS. 9 and 10 with a prime (″) symbol.

The housing 9″ includes a pump cylinder 20″ formed therein. An inner wall 21″ of the pump cylinder 20″ is formed to define a cavity 19″ adapted to receive the foam pump assembly 200 therein. The foam pump assembly 200 includes a hollow liquid piston 208, an air piston 210, a pair of springs 220, 221, and a ball 222 disposed in a cylindrical housing 230. The liquid piston 208 together with a portion of the housing 230 forms a liquid pump chamber 232. The air piston 210 together with a portion of the housing 230 and the liquid piston 208 form an air pump chamber 212. Both the liquid pump chamber 232 and the air pump chamber 212 are in fluid communication with a mixing chamber 252. One such foam pump assembly is described in the above-referenced in U.S. Patent Application Publication No. 2006/0157512 to van der Heijden entitled DISPENSING DEVICE WITH PISTON PUMP incorporated herein by reference in its entirety. Other foam pump assemblies can be employed in the fluid dispenser as desired. The housing 230 includes an inlet end and an outlet end. The inlet end is received within a substantially closed first end 22″ of a cylinder 20″. The first end of a cylinder 20″ includes an inlet 28″ in fluid communication with a fluid reservoir. It is understood that a valve can be disposed in the inlet 28″ if desired. The outlet end of the housing 230 extends laterally outwardly from a substantially open second end 24″ of the cylinder 20″.

When the foam pump assembly 200 is disposed in the cylinder 20″, a seal 240 is also disposed therein. The seal 240 is adapted to militate against a migration of a fluid mass into the second end 24″ of the cylinder 20″ and an accumulation thereof around the foam pump assembly 200. The seal 240 is a generally cylindrically-shaped member having an inner sealing surface and an outer sealing surface. The inner sealing surface of the seal 240 is adapted to contact the housing 230 of the foam pump assembly 200 to form a substantially fluid-tight seal therebetween. The outer sealing surface of the seal 240 is adapted to contact the inner wall 21″ of the first end 22″ of the cylinder 20″ to form a substantially fluid-tight seal therebetween. An annular radially outwardly extending lip 242 is formed integrally with the seal 240. The annular lip 242 is adapted to contact a shoulder 26″ of the cylinder 20″ to form a substantially fluid-tight seal therebetween.

The seal 240 includes a camming surface 244 inclined outwardly from the inner sealing surface of the seal 240 to the outer sealing surface of the seal 240. The camming surface 244 is adapted to seat in an annular trough formed in the foam pump assembly 200. The seal 240 can be produced from any conventional material such as an elastomer, for example. As a non-limiting example, the seal 240 is produced from a 55 durometer Santoprene®.

The foam pump assembly 200 is secured in the cylinder 20″ by affixing a closure ring 70″ to a lip 30″ of the cylinder 20″. The closure ring 70″ is affixed by any conventional means of attachment such as a snap fit, for example. The outlet end of the foam pump assembly 200 extends through an aperture formed in the closure ring 70″ for attachment to an actuator 80″.

The actuator 80″ includes opposing leg sections 81″ and an interconnecting cross-member section 82″ extending therebetween. The leg sections 81″ cooperate with guide rails provided on the outer surface of the cylinder 20″ to slideably support the actuator 80″ during operation. A discharge conduit 83″ formed in the cross-member section 82″ is generally L-shaped and includes an inlet 84″ and a downwardly protruding outlet 85″. The inlet 84″ may include at least one radially inwardly extending protuberance 86″ and is adapted to receive the outlet end of foam pump assembly 200, to create a substantially fluid-tight interference fit therebetween.

In operation, the liquid piston 208 and the air piston 210 of the foam pump assembly 200 and the actuator 80″ are in a first or “at-rest” position, as shown in FIG. 9. Thereafter, an operator urges the actuator 80″ in a first direction to slideably move the liquid piston 208 and the air piston 210 within the housing 230 to a second or “compressed” position as shown in FIG. 10. Accordingly, the spring 220 disposed therein is compressed and a pressure within the liquid pump chamber 232 and a force of the fluid mass disposed therein are increased. The increased pressure within the liquid pump chamber 232 and the force of the fluid mass disposed therein cause the fluid mass to flow through the liquid piston 208 to a mixing chamber 252. The movement of the air piston 210 increases a pressure within the air pump chamber 232 and a force of the air disposed therein to cause the air to flow from the air pump chamber 242 to the mixing chamber 252. In the mixing chamber 252, the fluid mass and the air combine to produce a foam. The foam is permitted to flow through the hollow interior of the foam pump assembly 200 and into and through the discharge conduit 83″ of the actuator 80″.

Thereafter, the liquid piston 208 and the air piston 210 are caused to slideably move in a second and opposite direction by the spring 220. The movement of the liquid piston 208 and the air piston 210 subsequently cause the actuator 80″ to move in the second direction. Accordingly, the liquid piston 208, the air piston 210, and the actuator 80″ are returned to the first position as shown in FIG. 9.

Once the pressure in the air pump chamber 242 and the liquid pump chamber 232 are decreased, air is received into the air pump chamber 242 and a pressure within the first end 22″ of the cylinder 20″ and a force of the fluid mass therein cause the ball 222 to unseat and the spring 221 to compress, as shown in FIG. 10. Accordingly, a fluid mass is permitted to flow from within the first end 22″ of the cylinder 20″ into and through the inlet end of the foam pump assembly 200 to the liquid pump chamber 232. When the pressure within the cylinder 20″ has decreased and the force of the fluid mass is less than the resistance force of the spring 221, the spring 221 urges the ball 222 to return to a seated position, as shown in FIG. 9. Fluid then flows by gravity from the fluid reservoir into the first end 22″ of the cylinder 20″. As the fluid fills the cylinder 20″, the seal 240 disposed between the housing 230 of the foam pump assembly 200 and the inner wall 21″ of the cylinder 20″ militates against the migration of the fluid into the second end 24″ of the cylinder 20″ and the accumulation of the fluid around the foam pump assembly 200.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A housing for storing and dispensing a fluid comprising:
a hollow pump cylinder having an inner wall formed to define a cavity for selectively receiving a liquid pump assembly and a foam pump assembly.

2. The housing according to claim 1, wherein the pump cylinder includes a plurality of guide rails formed thereon to slideably support an actuator.

3. The housing according to claim 1, wherein the pump cylinder includes a first end and a second end, the first end of the cylinder having a smaller diameter than the second end.

4. The housing according to claim 1, further comprising a front wall, opposing side walls, a rear wall, and a base, wherein the walls are substantially vertical and cooperate to define a fluid reservoir.

5. A fluid dispenser comprising:
a housing for selectively receiving one of a liquid pump assembly and a foam pump assembly, the liquid pump assembly including a hollow piston rod, a hollow piston cup, and a valve, the housing having a hollow pump cylinder formed therein including a first end having an inlet in fluid communication with a fluid reservoir, and a second end having a larger diameter than a diameter of the first end; and
an actuator adapted to operate both the liquid pump assembly and the foam pump assembly.

6. The fluid dispenser according to claim 5, wherein the inlet of the pump cylinder is adapted to receive a valve therein.

7. The fluid dispenser according to claim 5, wherein the hollow piston rod of the liquid pump assembly includes a positioning mechanism formed thereon adapted to be slideably received in the cylinder.

8. The fluid dispenser according to claim 7, wherein the positioning mechanism is at least one of an annular collar and a plurality of flutes.

9. The fluid dispenser according to claim 5, wherein the piston cup includes an annular collar adapted to be slideably received in the pump cylinder.

10. The fluid dispenser according to claim 5, wherein the piston cup is provided with a campanular portion slideably received in the cylinder.

11. The fluid dispenser according to claim 5, wherein the valve of the liquid pump assembly includes a spring and a ball.

12. The fluid dispenser according to claim 5, wherein the pump cylinder includes a plurality of guide rails adapted to slideably support the actuator.

13. The fluid dispenser according to claim 5, wherein the pump cylinder cooperates with a seal disposed therein to militate against a migration of a fluid to and an accumulation thereof around the foam pump assembly.

14. A fluid dispenser comprising:
a housing having a front wall, opposing sidewalls, a rear wall, and a base, wherein the walls are substantially vertical and cooperate to define a fluid reservoir, and wherein the base includes a hollow pump cylinder formed therein, the hollow pump cylinder including a first end having an inlet in fluid communication with the fluid reservoir, a second end having a larger diameter than a diameter of the first end, and a plurality of guide rails formed thereon, and wherein the pump cylinder is adapted to selectively receive one of a liquid pump assembly and a foam pump assembly, the liquid pump assembly including a hollow piston cup, a valve, and a hollow piston rod having a positioning mechanism formed thereon, wherein the positioning mechanism is adapted to be slideably received in the second end of the pump cylinder; and
an actuator adapted to operate both the liquid pump assembly and the foam pump assembly, the actuator slideably supported on the guide rails of the pump cylinder.

15. The fluid dispenser according to claim 14, wherein the inlet of the pump cylinder is adapted to receive a valve therein.

16. The fluid dispenser according to claim 14, wherein the positioning mechanism of the liquid pump assembly is at least one of an annular collar and a plurality of flutes.

17. The fluid dispenser according to claim 14, wherein the piston cup of the liquid pump assembly includes an annular collar adapted to be slideably received in the second end of the pump cylinder.

18. The fluid dispenser according to claim 14, wherein the piston cup of the liquid pump assembly is provide with a campanular portion adapted to be slideably received in the first end of the cylinder.

19. The fluid dispenser according to claim 14, wherein the valve of the liquid pump assembly includes a spring and a ball.

20. The fluid dispenser according to claim 14, wherein the pump cylinder cooperates with a seal disposed therein to militate against a migration of a fluid to and an accumulation thereof around the foam pump assembly.
